(19) United States
(12) Patent Application Publication
(10) Pub. No.: US 2010/0198668 A1
(43) Pub. Date: Aug. 5, 2010

(54) Method for Promoting a Product or Service

(75) Inventor: Lynda Rae Resnick, Beverly Hills, CA (US)

Correspondence Address: LOEB & LOEB, LLP, 321 NORTH CLARK, SUITE 2300, CHICAGO, IL, 60654-4746, US

(73) Assignee: Teleflora LLC, Los Angeles, CA (US)

(21) Appl. No.: 12/414,088

(22) Filed: Mar. 30, 2009

Related U.S. Application Data
(60) Provisional application No. 61/148,817, filed on Jan. 30, 2009.

(51) Int. Cl. G06Q 30/00

(52) U.S. Cl. 705/14.4; 705/1.1

(57) ABSTRACT

A method of promoting a product or service is disclosed, the method comprising the steps of identifying an object representative of a competing product or service, identifying an undesirable natural attribute and an unnatural attribute associated with the object, simultaneously applying the natural attribute and unnatural attribute to the object, and presenting the object having the natural and unnatural attributes to a user via the user interface so as to convey to the user that the competing product or service is inferior to the product or service being promoted.

### STATEMENT OF RELATED APPLICATIONS

This application claims priority to U.S. Provisional Application Ser. No. 61/148,817 filed Jan. 30, 2009, which is incorporated herein by reference in its entirety to the extent permitted by law.

### FIELD OF THE INVENTION

This invention relates to a method for promoting or advertising and more particularly, to a method for promoting or advertising a product or service using anthropomorphic objects.

### BACKGROUND

The consuming public has become more and more resistant to advertising. Commercials are often fast-forwarded over using digital video recorder technology. Print ads are less acceptable as consumers turn toward a “greener” lifestyle. Internet advertising is less effective in capturing the attention of consumers who prefer to select “Skip Advertisement,” or to block pop-ups. Accordingly, advertisers are continually seeking more interesting and entertaining ways of advertising and promoting products and services to consumers who are likely to ignore efforts at capturing their attention.

Various unique methods and techniques of advertising and promoting products and services are known. For example, advertising techniques are known whereby customers are presented with a distinctive or characteristic odor or smell associated with a product simultaneously with the visual display or presentation of such goods to the customer. However, such techniques are generally useful for only certain types of products, and in limited locations.

As another example, catchy slogans such as WHERE'S THE BEEF® and GOT MILK?® are used as marketing tools to promote various products and services. However such slogans can become irritating and may quickly lose effectiveness.

Accordingly there is a need for a more unique and effective long-term method or technique for promoting goods and services.

### SUMMARY OF THE INVENTION

A method of promoting a product or service is disclosed, the method comprising the steps of identifying an object representative of a competing product or service, identifying an undesirable natural attribute and an unnatural attribute associated with the object, simultaneously applying the natural attribute and unnatural attribute to the object, and presenting the object having the natural and unnatural attributes to a user via the user interface so as to convey to the user that the competing product or service is inferior to the product or service being promoted.

Also disclosed is a method of conveying a message to a user about the quality of a promoted product or service, the method comprising presenting the user with an anthropomorphic object representing a competing product or service, identifying at least one undesirable characteristic associated with the competing product or service, applying the undesirable characteristic to the anthropomorphic object, and conveying to the user via a user interface that the competing product or service is inferior to the promoted product or service by the application of the undesirable characteristic to the anthropomorphic object.

Also disclosed is a method of promoting a product or service comprising the steps of anthropomorphizing an inanimate object representative of a competing product or service, attributing an undesirable characteristic associated with the competing product or service to the inanimate object, and conveying to a user via a user interface that the competing product or service is inferior to the product or service being promoted based on the attribution of the undesirable characteristic to the inanimate object.

### BRIEF DESCRIPTION OF THE DRAWINGS

The invention may be better understood by references to the detailed description when considered in connection with the accompanying drawings. The components in the figures are not necessarily to scale, emphasis instead being placed upon illustrating the principles of the invention. In the figures, like reference numerals designate corresponding parts throughout the different views.

FIG. 1 is a flow diagram illustrating one embodiment of a method for promoting a product or service according to the present invention.

FIG. 2 illustrates an anthropomorphic bouquet of wilted flowers used as a representative object in connection with an implementation of a method of promoting a product or service.

FIG. 3 illustrates wilted talking flowers used as representative objects in connection with an implementation of a method of promoting a product or service.

FIGS. 4a-c illustrate an example of an animated anthropomorphic figure that may represent a product or service being promoted, and that may be featured within advertising content, the figure being illustrated in three different human-like positions.

### DETAILED DESCRIPTION OF THE INVENTION

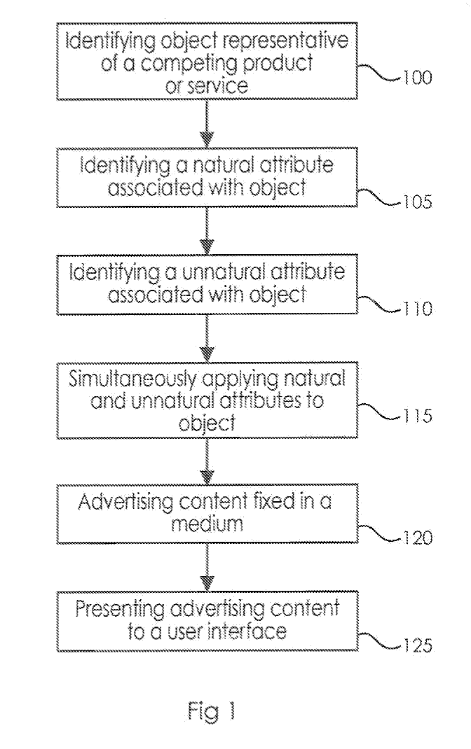

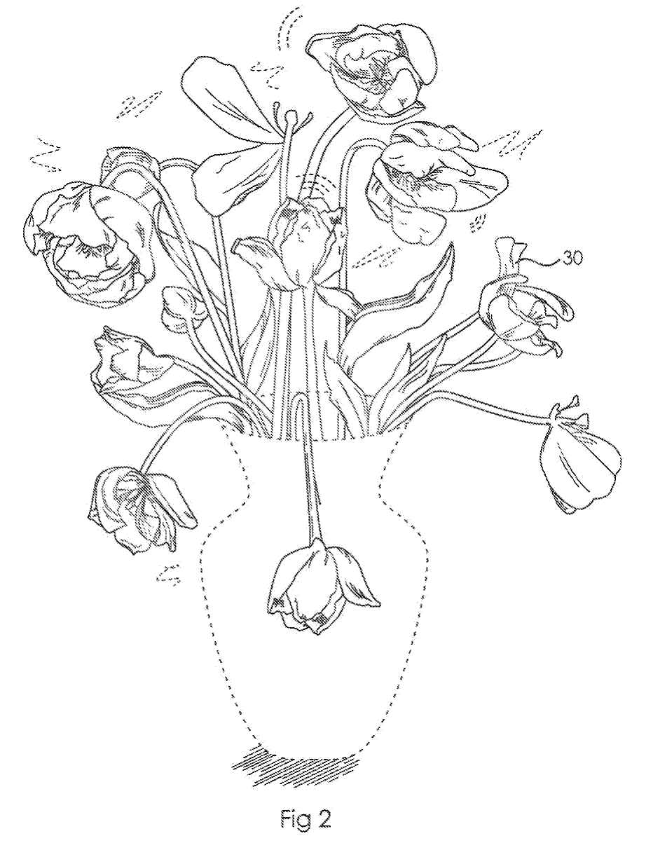

FIG. 1 is a flow diagram illustrating one embodiment of a method of promoting a product or service in accordance with the invention. Initially, an object is identified that represents a product or service that competes with the product or service being promoted (step 100). The representative object may be, for example, any physical object generally thought of by the public as being associated with the particular product or service that competes with the product or service being promoted. For example, if the service being promoted is a floral delivery service, the identified object may be a bouquet of flowers 30 (as shown in FIG. 2) that is sold or delivered by a competing floral delivery service. In another example, when promoting a laundry detergent, the identified object may be an article of clothing that has been cleaned by a competing detergent. In yet another example, if the service being promoted is a courier or delivery service, the identified object may be a package delivered by a competing delivery or courier service. The above illustrates only examples of the types of objects that may be identified to represent a competing product or service, as set forth in step 100 of FIG. 1. One of skill in the art would understand that the possibilities are limitless as to the representative object to be identified.

Next, a natural attribute associated with the representative object is identified (step 105). In this step 105, a natural attribute is one that is naturally associated with the representative object. For example, an article of clothing may have the following natural attributes (by way of example only): soft, wrinkled, striped, silky, pleated, new, ripped, colorful, dirty, stained. On the other hand, an unnatural attribute of an object is one that is not naturally occurring with respect to that object, for example: intelligent, literate, animate, electronic, alive, hostile, antagonistic, intimidating, derisive, unfriendly, sarcastic, mean, sad.

In one embodiment of the method of FIG. 1, the natural attribute associated with the representative object may be a quality or characteristic that is perceived by the purchasing public to be undesirable when associated with that object. For example, in the floral delivery service example discussed above with respect to FIG. 1, the public generally perceives flowers that are wilted or withered to be undesirable, particularly in the context of floral delivery service. Thus, the identified natural attribute or characteristic associated with the bouquet of flowers (FIG. 2) may be wilting or withering (step 105). In other examples, stained, wrinkled, or ripped may be undesirable natural attributes associated with an article of clothing representative of a laundry detergent. In yet another example, lost, late, dropped, broken or ripped may be undesirable natural attributes associated with a package representative of a delivery or courier service. It will be understood that more than one natural attribute may be identified in step 105.

Next, an unnatural attribute associated with the representative object is identified (step 110). In one embodiment, where the representative object is naturally inanimate, the unnatural attribute associated with the object may be a human or human-like characteristic, such as, for example, verbally literate or animated (e.g., exhibiting human-like movements or gestures, such as clapping, talking, singing; winking, dancing). For example, in the context of floral delivery services as discussed above, the step of identifying an unnatural attribute associated with the bouquet of flowers may include identifying “talking” or “dancing” as the unnatural attribute. In the other examples discussed above, the unnatural attribute associated with an article of clothing and/or a delivered package may also be identified as “talking” or “dancing.” While the examples above describe the identified unnatural attribute associated with an inanimate object as being human-like in nature, one of skill in the art would appreciate that other unnatural attributes, such as electronic, robotic or motorized may be identified in step 110. Further, it should be understood that more than one unnatural attribute may be identified in step 110.

Next, the natural and unnatural attributes identified at steps 105 and 110 are simultaneously applied to the representative object (step 115). For example, again referring to the floral delivery service example discussed above, the unnatural attributes of talking and having human mobility may be applied to the representative object, e.g., a bouquet of wilting or withering flowers, as shown in FIG. 2. In this embodiment, the pedals of one or more of the wilted (undesirable natural attribute) flowers 30 may be synchronized with an audio narrative to mimic a human-like mouth, giving the appearance of talking (unnatural attribute) flowers. In addition the leaves of the flowers may also move in synchronization with the audio narrative to mimic human-like movement of arms. The animation and/or synchronization may be performed with the aid of a general purpose computer or graphics terminal.

In another example, the unnatural attributes of talking and animation may be applied to a stained shirt, or to the stain itself. In this example, the stain (undesirable natural attribute of clothing) may, for example, be shaped so as to have the appearance of having a mouth, and the mouth may be made to move and talk (unnatural attribute) such that it is synchronized with an audio narrative. The animation and/or synchronization may be performed with the aid of a general purpose computer or graphics terminal.

In yet another example, the unnatural attributes of talking and animation may be applied to a package. In this example, the package may be ripped (undesirable natural attribute) such that the rip may give the package the appearance of having a mouth formed on a face of the package, and the mouth may be made to move such that it is synchronized with an audio narrative. Alternatively, or in addition, the package may have been dropped such that the contents of the package are broken. An unnatural attribute of the package may be jumping, such that the broken (undesirable natural attribute) contents of the package may be shown by making a jingling or rattling sound when the package jumps about (unnatural attribute).

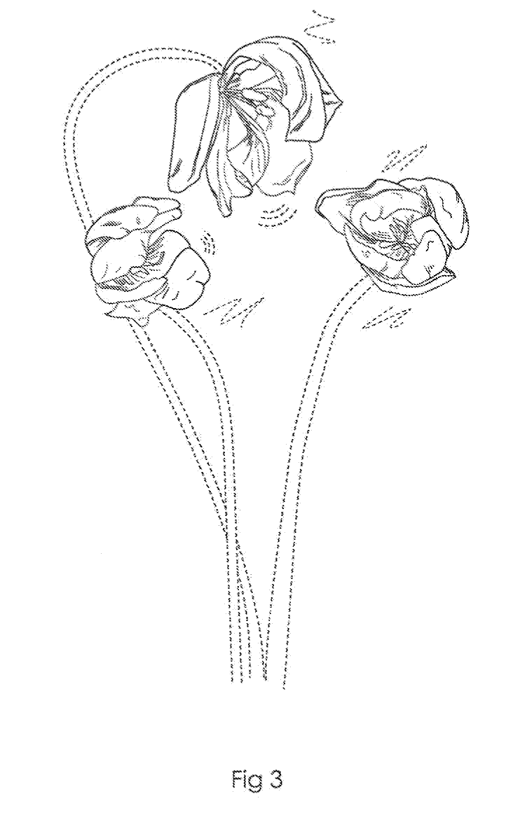

FIGS. 2 and 3 illustrate two implementations of anthropomorphic wilted flowers that may be used as representative objects having both natural and unnatural attributes applied to them, in connection with an implementation of a method of promoting a product or service. After applying the natural (wilted) and unnatural (animated and talking), the representative object (here, for example, flowers) may be depicted as anthropomorphic wilted flowers in a two-dimensional or three-dimensional rendering. The rendering may be generated by, for example, any graphic design, computer aided design, or desktop publishing software. Once generated, the representative anthropomorphic wilted flowers may be automated such that they move in synchronization with a pre- or post-recorded audio stream. The object may be automated by, for example, any appropriate known computer animation, digital animation or computer-generated imagery software.

Returning to FIG. 1, once simultaneously applying natural and unnatural attributes to a representative object, advertising content may be fixed in a known medium (step 120). The advertising content may include, for example, the representative object conferred with the identified natural and unnatural attributes, in combination with a slogan, jingle, script, statement, comment, or other type of copy generally known and used in the advertising industry. Such advertising content may be fixed in any audio or visual format, including any tangible format commonly known such as, for example, a digital audio and/or analog tape, compact disc, floppy disks, DVDs, CD-ROMs, hard and portable drives, SD cards, flash memory, and hard copy print. Once the advertising content is fixed in a medium (step 120), it may then be presented to users via a user interface (step 125). The user interface may be any known means of display, distribution or broadcasting, including, for example, a computer display screen, a billboard, a movie theater screen, a television display, or a print advertisement.

As an example of an advertisement for flower delivery services presented to a user via a user interface, one or more wilted flowers, or a bouquet of wilted flowers, intended to represent flowers sold by a competing floral delivery service, may be illustrated. The flowers may be portrayed in a moving or still video or photograph that has been altered, digitally or by hand, such that the flowers have an anthropomorphic or “living” appearance. For example, the pedals may be made to mimic a mouth and/or the leaves may be made to mimic human arms making various movements and gestures. In the case of a video advertisement, an audio stream may be added to the altered video to give the sound and appearance of the flowers talking. In the case of a still advertisement, a bubble call-out (as in a classic comic book) may be added to indicate speech from one or more of the wilted flowers.

In one embodiment, the text of the narrative may be drafted so as to suggest that the competitor's service is inferior, and that buying flowers through such a competitive delivery service sends a message to the recipient opposite to what is intended by the flowers. For example, the advertisement may show a bouquet of wilted talking flowers sent to a new mother holding her newborn baby. The messages someone typically wants to convey when sending flowers to a new mother are: “Congratulations on your new baby” or “We look forward to your return to work” or “We can't wait to meet your little one.” However, in accordance with one embodiment of the invention, the wilted flowers may have the additional unnatural attribute of hostility or sarcasm, and be made to “speak” derisive, sarcastic or hostile remarks, such as, “Oh, you were pregnant? We thought you were just fat!” or “We're glad your out of the office—now we can steal your projects!” or “Is it a boy or a girl? It's so ugly, who cares!?!” In a print advertisement, these comments may be written in a bubble callout as in classic comic strips or books. The derisive comments made by the flowers are intended to convince viewers to use the services of the person or company promoting the product, rather than the inferior services represented by the wilted, sarcastic flowers.

In another example implementation of the method disclosed, an advertisement for laundry detergent may be presented to users via a user interface. In such an advertisement, a stained article of clothing (e.g., a shirt) just out of the washing machine may be illustrated, the stained shirt intended to represent a competitor's product. The shirt may be portrayed in a moving or still video or photograph that has been altered, digitally or by hand, such that the shirt appears to be animated or “living.” For example, the shirt may appear to be standing on its own with the shirt-sleeve made to mimic the arms of a human making various movements or gestures. In the case of a video advertisement, an audio stream may be added to the altered video to give the appearance of the shirt or stain talking. In the case of a still advertisement, a bubble call-out may be added to indicate speech from the shirt or stain, as in a comic strip or book.

In one embodiment, the text of the narrative for the laundry detergent advertisement may be drafted so as to suggest that the competitor's detergent is inferior, and that buying the competitor's product sends a message to the recipient opposite to what is intended by a high quality laundry detergent. For example, the advertisement may show a person getting ready for a first date pulling the stained shirt out of the washing machine. The messages someone typically wants to convey when on a first date is: “I want to look my best for you” or “I'm a nice, clean-cut, together person.” However, in accordance with one embodiment of the invention, the stained shirt may have the additional unnatural attribute of hostility or sarcasm, and be made to “speak” derisive, sarcastic or hostile remarks, such as, “Why even bother—she'll probably stand you up anyway” or “Don't even try to pull yourself together—it's never gonna happen!” In a print advertisement, these comments may be written in a bubble callout as in classic comic strips or books. The derisive comments made by the shirt or stain are intended to convince viewers to buy the laundry detergent of the person or company promoting the product, rather than the inferior product represented by the stained shirt.

In yet another example implementation of the method disclosed, an advertisement for a courier service may be presented to users via a user interface, such as a computer display screen, a movie theater screen, a television display, or a print advertisement. In such an advertisement, a smashed-up or torn package may be illustrated, representing the courier services of a competing company. The package may be portrayed in a moving or still video or photograph that has been altered, digitally or by hand, such that the package appears to be animated or “living.” For example, the package may have several large tears that appear to be the eyes and/or mouth of the package, so as to mimic the face of a person. In the case of a video advertisement, an audio stream may be added to the altered video to give the appearance of the package talking. In the case of a still advertisement, a bubble call-out may be added to indicate speech from the package, as in a comic strip or book.

In one embodiment, the text of the narrative for the courier service advertisement may be drafted so as to suggest that the competitor's service is inferior, and that using the competitor's service sends a message opposite to what is intended by a high quality courier service. For example, the advertisement may show a person receiving a birthday gift sent via the competitor's courier service. The messages someone typically wants to convey when sending a birthday gift is: “Happy Birthday” or “Have a great day on your special day.” However, in accordance with one embodiment of the invention, the torn package may have the additional unnatural attribute of hostility or sarcasm, and be made to “speak” derisive, sarcastic or hostile remarks, such as, “We wanted to send you something that looks as old as you do,” or “Who cares if this vase is cracked—you're probably too old to see the crack anyway!” In a print advertisement, these comments may be written in a bubble callout as in classic comic strips or books. The derisive comments made by the package are intended to convince viewers to use the company promoting the service to deliver your package, rather than the inferior service represented by the smashed package.

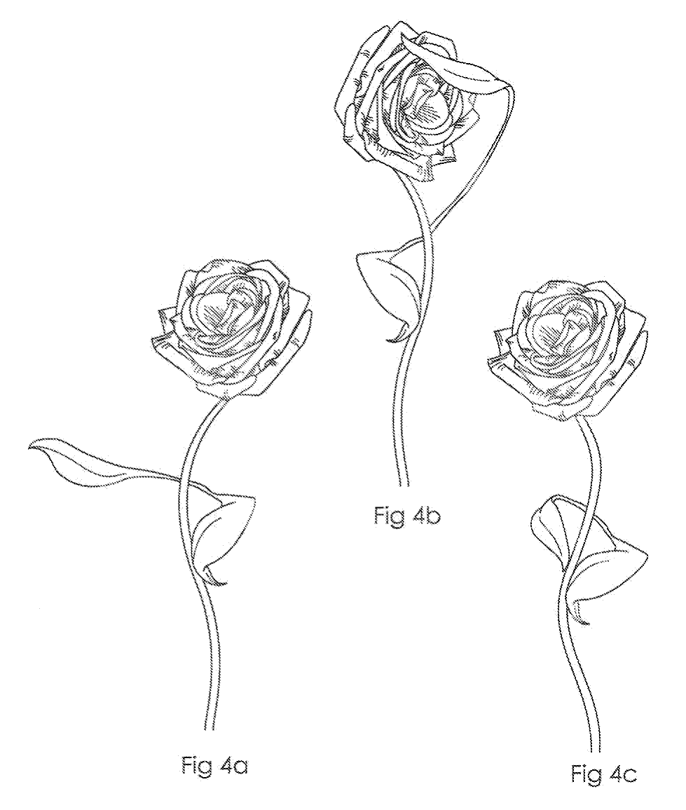

In other embodiments, as illustrated in FIGS. 4a-c, animated anthropomorphic figures in accordance with the present invention may represent the product or service being promoted (rather than a competitor's product or service), and may be featured as part of the advertising content, via, for example, the Internet, television, or print advertising. For example, an anthropomorphic flower 350 may be featured, wherein the flower 350 is a beautiful, perfect rose. Rather than mocking or deriding the competitor's product or service, the illustrated flower represents the high quality, desirable features of the company promoting the product or service. In this example, the flower 350 may be an anthropomorphic figure that interacts with users via a website to solicit users to purchase flowers or other related products and services. In this way, the pedals and/or leaves of the flower may be animated to move in syncopation with music or an audio narrative describing the promoted product or service. As illustrated in FIGS. 4a-c, the anthropomorphic flowers are made to have a human-like or living appearance. These flowers may convey audio messages that reiterate what is intended to convey by the delivery of flowers, such as “Hope your birthday is as wonderful as you are!” or “Congratulations on the birth of your beautiful baby! Hurry back to work soon—we miss you!”

By way of another example, the animated flower 350 may “sing” a well-known holiday jingle that is known to engender feelings of happiness and/or nostalgia. In yet another embodiment, the flower 350 may interact with the user to navigate the user through the web pages of the website. As will be appreciated by those of ordinary skill in the art, the present invention provides a wide variety of applications for promoting products and services via the Internet.

The advertising content described above may be delivered to a user in any number of conventions means. For example, the advertising content may be disseminated via a television broadcasters such as NBC®, ABC®, CBS®, and the like. Alternatively, the advertising content may be presented to an end-user via a communications network, such as the Internet, the World-Wide Web, or a wireless Internet network. In any such communications network, the network may include an end-user computer that connects to, and communicates with, a host server. Advertising content may be stored on the host server. The content may then be communicated from the host server via the Internet to the end-user computer, where the advertisement is broadcast to the end-user via a computer having a user-interface display, such as a cathode ray tube (“CRT”), liquid crystal display (“LCD”), or plasma display.

As yet another example of a means for delivering the above-described advertising content, the advertising content may be delivered via a mobile broadcasting network that includes, for example, a broadcast center, a satellite, and a mobile receiver having a display. The mobile receiver may be, for example, radiotelephones, mobile telephones, cellular telephones, smartphones, wireless-enabled PDAs, wireless-enabled portable computers, network-enabled devices such as PCs, TV set top boxes and other similar devices. The mobile broadcasting network may include a satellite digital multimedia broadcasting (“DMB”) network and/or a terrestrial DMB network.

As will be understood by those of skill in the art, the advertising content may be delivered by other means, including print advertisements, billboards, electronic billboard, and marketing materials such as t-shirts and other clothing, mouse pads, coffee mugs, water bottles, coupons, sweepstakes or contests, and note pads.

Having described illustrative embodiments incorporating the present invention, it is to be understood that other embodiments may also be used. It will be appreciated that various modifications and changes may be made to the embodiments disclosed herein and all such modifications and changes are within the scope of the following claims.

I claim:

1. A method of promoting a product or service comprising:
identifying an object representative of a competing product or service;
identifying one or more natural attributes associated with the object and one or more unnatural attributes associated with the object, wherein at least one of the natural attributes is an undesirable characteristic of the object;
simultaneously applying the natural attributes and the unnatural attributes to the object; and
presenting the object having the natural and unnatural attributes to a user via a user interface so as to convey to the user that the competing product or service is inferior to the product or service being promoted.

2. The method of claim 1 wherein the user interface comprises a computer display screen.

3. The method of claim 1 wherein the user interface comprises a television display.

4. The method of claim 1 wherein the user interface comprises a mobile unit with a display.

5. The method of claim 1 wherein the user interface comprises a billboard.

6. The method of claim 1 wherein the user interface comprises a hard copy print media.

7. The method of claim 1 wherein at least one of the natural attributes of the object is selected from the group comprising torn, wilted, stained, and dirty.

8. The method of claim 1 wherein at least one of the unnatural attributes of the object is selected from the group comprising intelligent, literate, animate, electronic, alive, robotic, motorized, hostile, antagonistic, intimidating, derisive, unfriendly, sarcastic, mean and sad.

9. A method of conveying a message to a user about the quality of a promoted product or service, the method comprising:
presenting the user with an anthropomorphic object representing a competing product or service;
identifying at least one undesirable characteristic associated with the competing product or service;
applying the undesirable characteristic to the anthropomorphic object; and
conveying to the user via a user interface that the competing product or service is interior to the promoted product or service by the application of the undesirable characteristic to the anthropomorphic object.

10. The method of claim 9 wherein the user interface comprises a computer display screen.

11. The method of claim 9 wherein the user interface comprises a television display.

12. The method of claim 9 wherein the user interface comprises a mobile unit with a display.

13. The method of claim 9 wherein the user interface comprises a billboard.

14. The method of claim 9 wherein the user interface comprises a hard copy print media.

15. The method of claim 9 wherein the undesirable characteristic is selected from the group comprising torn, wilted, stained, or dirty.

16. The method of claim 15 wherein the anthropomorphic object has an attitude selected from the group comprising hostile, antagonistic, intimidating, derisive, unfriendly, sarcastic, mean and sad.

17. A method of promoting a product or service comprising the steps of:
anthropomorphizing an inanimate object representative of a competing product or service;
attributing an undesirable characteristic associated with the competing product or service to the inanimate object; and
conveying to a user via a user interface that the competing product or service is inferior to the product or service being promoted based on the attribution of the undesirable characteristic to the inanimate object.

18. The method of claim 17 wherein the user interface comprises a computer display screen.

19. The method of claim 17 wherein the user interface comprises a television display.

20. The method of claim 17 wherein the user interface comprises a mobile unit with a display.

21. The method of claim 17 wherein the user interface comprises a billboard.

22. The method of claim 17 wherein the user interface comprises a hard copy print media.

23. The method of claim 17 wherein the undesirable characteristic is selected from the group comprising torn, wilted, stained, or dirty.

24. The method of claim 23 wherein the anthropomorphized inanimate object has an attitude selected from the group comprising hostile, antagonistic, intimidating, derisive, unfriendly, sarcastic, mean and sad.
